(19) United States
(12) Patent Application Publication
(10) Pub. No.: US 2026/0171722 A1
(43) Pub. Date: Jun. 18, 2026

(54) METHOD OF TERMINATING AN ELECTRICAL CONDUCTOR

(71) Applicant: RMSPUMPTOOLS Limited, Aberdeen (GB)

(72) Inventors: Nigel AMES, Manchester (GB); Paul BENSON, York Yorkshire (GB); Robert Stuart JOHNSTON, Carlisle Cumbria (GB)

(21) Appl. No.: 18/677,040

(22) PCT Filed: Nov. 24, 2022
(86) PCT No.: PCT/GB2022/052974

§ 371 Date: May 29, 2024

(30) Foreign Application Priority Data
Dec. 1, 2021 (GB) 2117373.7

(51) Int. Cl. H01R 13/639; H01R 13/187; H01R 13/52; H01R 13/58; H01R 13/627

(52) U.S. Cl. CPC H01R 13/6397; H01R 13/187; H01R 13/5205; H01R 13/5208; H01R 13/5219; H01R 13/5833; H01R 13/6272; H01R 13/6275

(57) ABSTRACT

A method of terminating an electrical conductor for a wellhead comprises passing the conductor through a gland, and engaging the conductor and the gland with a positioning tool. First and second abutments on the positioning tool respectively limit movement of the gland and the electrical conductor relative to the positioning tool in first and second directions. The gland is fixed to the electrical conductor, the positioning tool is disengaged, and the electrical conductor offered to a connector. The gland engages with the connector. First and second abutments on the connector respectively limit movement of the gland and the conductor relative to the connector in the first and second directions. The axial distance between the first and second abutments on the positioning tool approaches or equals the axial distance between the first and second abutments on the connector portion.

This disclosure relates to a method of terminating an electrical conductor such as an electrical cable, which in one example, is adapted for use on a well, such as an oil or gas well. Electrical conductors such as cables are connected through the wellhead on wells via wellhead penetrators to which they are connected by mating connector portions. Electrical equipment used in the vicinity of oil and gas wells generally needs to be certified for use in explosive atmospheres, and the surface portions of wellhead connectors are typically factory-assembled under controlled conditions to exact specifications that meet requirements for operation in such areas.

The invention provides a method of terminating an electrical conductor for connection to a wellhead of an oil or gas well, the method comprising:
passing the electrical conductor through a bore of a gland;
engaging the electrical conductor with a positioning tool;
engaging the gland with the positioning tool;
limiting movement of the gland relative to the positioning tool in a first direction;
limiting movement of the electrical conductor relative to the positioning tool in a second direction, wherein the second direction is opposite to the first direction;
fixing the gland to the electrical conductor;
disengaging the positioning tool from the gland and the electrical conductor;
passing the electrical conductor through the body of a connector portion;
engaging the gland with the connector portion;
limiting movement of the gland relative to the connector portion in the first direction; and
limiting movement of the electrical conductor relative to the connector portion in the second direction.

Optional features are set out in the dependent claims.

Optionally the positioning tool has a first abutment which engages the gland to limit the movement of the gland relative to the positioning tool in the first direction, and optionally a second abutment which engages a locking device to limit the movement of the electrical conductor relative to the positioning tool in the second direction.

Optionally the connector portion has a first abutment which engages the gland to limit the movement of the gland relative to the connector portion in the first direction, and optionally a second abutment which engages the locking device to limit the movement of the electrical conductor relative to the connector portion in the second direction. Optionally the axial distance between the first and second abutments on the positioning tool is within 10% of the axial distance between the first and second abutments on the connector portion, optionally within 5%, and optionally the axial distance between the first and second abutments on the positioning tool is equal to as the axial distance between the first and second abutments on the connector portion.

Optionally the positioning tool has a bore, and optionally the gland and conductor portion have bores that are coaxial with the bore of the positioning tool. Optionally the conductor has a free end and the free end is passed through the gland, the positioning tool and the connector portion, e.g. through the bores thereof. Optionally the free end has an end termination for each conductor, optionally in the form of a pin, adapted to engage with a socket on a mating connector portion to connect the electrical conductor on one side of a connection with the electrical conductor on another side. The conductor can comprise a conductor core within a cable, which can have one, two or three (or more) conductor cores.

Optionally the gland has a body with an axis and a seal adapted to seal an annulus between the bore of the gland and the conductor. Optionally the bore of the gland extends axially between first and second ends of the body. Optionally the gland is fixed to the outer surface of the conductor, optionally after engaging the gland with the positioning tool. Limiting the relative movement between the positioning tool and the electrical conductor and then engaging the gland with the positioning tool before fixing the gland to the outer surface of the conductor enables the relative axial positions of the gland and the conductor to be determined very precisely, before the gland is fixed to the conductor.

Optionally the relative movement is limited by a locking device. Optionally the locking device is adapted to lock its position relative to the conductor. Optionally when the locking device fixes to the conductor it limits movement of the conductor relative to the positioning tool in the second direction.

Optionally engaging the locking device with the second abutment locks the axial position of the positioning tool relative to the conductor, which can therefore be used to determine the position of the gland relative to the conductor as it engages with the positioning device.

The locking device optionally engages the conductor via a screw thread.

Optionally the gland is connected to the positioning tool to resist movement of the gland in the first direction relative to the positioning tool before movement of the electrical conductor is limited relative to the positioning tool in the second direction, e.g. by connection of the locking device to the electrical conductor. Alternatively, the locking device can be connected to the conductor before the gland is connected to the positioning tool.

When the locking device is engaged with the conductor, the locking device optionally limits movement in only one direction. Thus before the gland is attached to the electrical conductor, the gland and positioning tool can typically together move relative to the locking device in one direction, but optionally not in the opposite direction. Optionally the end of the positioning tool abutting the locking device has a recess in which the locking device is received.

Optionally the positioning tool has a third abutment which limits movement of the conductor relative to the positioning tool in the first direction; thus, in one example, the conductor is fixed to the positioning tool and cannot move in either axial direction. Optionally the third abutment on the positioning tool comprises an end face of a bore (optionally an inner end face) and is optionally engaged by a section of the pin which has a larger diameter than the bore through the end face.

Optionally the locking device has a body with an axis and a bore (optionally threaded) adapted to receive the electrical conductor. Optionally the locking device is adapted to be fixed to the electrical conductor.

Optionally the gland is adapted to be fixed to the positioning tool, optionally by a screw thread.

Optionally the positioning tool has an axis and optionally the bore of the positioning tool extends between first and second ends of the positioning tool. The bore is optionally axial.

Optionally the gland is fixed to the outer surface of the electrical conductor by a clamping device.

Optionally the method includes the step of passing the end of electrical conductor through a bore of a cable guide. The cable guide optionally separates multiple conductors from each other, and guides the bending of conductors toward bores in the connector.

Optionally the method includes the step of terminating the electrical conductor, optionally by attaching, e.g. crimping an electrical terminal such as a terminal pin onto a conductor core of the electrical conductor, typically prior to the step of limiting the movement of the gland relative to the positioning tool. Optionally the pin is adapted to engage with the locking device, optionally by a screw thread.

Optionally the conductor (e.g. the terminal pin) is placed in a rotational alignment tool during the termination process, which can be useful to establish a suitable rotational alignment between the terminal pin and the conductor, for optimal interconnection between the terminal pin (which may be rotationally non-symmetrical, for example, it may have an offset recess or bucket to receive the conductor core) and the connector portion. Optionally the pin(s) in one connector portion are adapted to stab into sockets on the mating connector portion on the other side of the connection.

Optionally the gland is fixed to the connector portion, optionally by a screw thread.

Optionally the connector portions are certified for operation in explosive atmospheres, and are adapted for use on a wellhead. At least one of the connector portions forms a portion of a wellhead penetrator. Optionally the gland, the connector body and the second connector portions are certified components.

In one aspect, the invention provides a method of terminating an electrical conductor for connection to a wellhead of an oil or gas well, the method comprising:
passing the electrical conductor through a bore of a gland;
engaging the electrical conductor with a positioning tool;
engaging the gland with the positioning tool;
limiting movement of the gland relative to the positioning tool in a first direction with a first abutment on the positioning tool;
limiting movement of the electrical conductor relative to the positioning tool in a second direction with a second abutment on the positioning tool, wherein the second direction is opposite to the first direction;
fixing the gland to the electrical conductor;
disengaging the positioning tool from the gland and the electrical conductor;
passing the electrical conductor through the body of a connector portion;
engaging the gland with the connector portion;
limiting movement of the gland relative to the connector portion in the first direction with a first abutment on the connector portion; and
limiting movement of the electrical conductor relative to the connector portion in the second direction with a second abutment on the connector portion, and wherein:
the axial distance between the first and second abutments on the positioning tool is equal to the axial distance between the first and second abutments on the connector portion.

The invention also provides a kit of parts for an electrical conductor for connection to a wellhead of an oil or gas well, the kit comprising:
a gland having a bore to receive the electrical conductor;
a positioning tool;
the gland and the positioning tool having formations adapted to connect the gland to the positioning tool;
a connector portion comprising a bore adapted to receive the electrical conductor;
the connector portion being adapted to connect to the formation on the gland;
wherein:
the positioning tool has a first abutment adapted to limit movement of the gland relative to the positioning tool in a first direction and a second abutment adapted to limit movement of the electrical conductor relative to the positioning tool in a second direction;
the gland is adapted to be fixed to the electrical conductor;
wherein the positioning tool can be disengaged from the gland and the electrical conductor after the gland is fixed to the electrical conductor, and wherein the connector portion is adapted to receive the electrical conductor after the positioning tool has been disengaged from the gland such that the connector portion engages the formation on the gland; and wherein:
the connector portion has a first abutment adapted to limit movement of the gland relative to the connector portion in the first direction and a second abutment adapted to limit movement of the electrical conductor relative to the connector portion in the second direction.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the spirit and scope of the present invention. Accordingly, each example herein should be understood to have broad application, and is meant to illustrate one possible way of carrying out the invention, without intending to suggest that the scope of this disclosure, including the claims, is limited to that example. Furthermore, the terminology and phraseology used herein is solely used for descriptive purposes and should not be construed as limiting in scope. In particular, unless otherwise stated, dimensions and numerical values included herein are presented as examples illustrating one possible aspect of the claimed subject matter, without limiting the disclosure to the particular dimensions or values recited. All numerical values in this disclosure are understood as being modified by “about”. All singular forms of elements, or any other components described herein are understood to include plural forms thereof and vice versa.

Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee.

### BRIEF DESCRIPTION OF THE DRAWINGS

In the accompanying drawings:

FIG. 1 shows an assembled connector assembly with an electrical cable having a connector portion made up according to one aspect of the present disclosure;

FIGS. 2-4a show sequential side views the electrical cable being terminated with terminal pins, and FIG. 4b shows an alternative rotational alignment tool being used in the termination process;

FIGS. 5a and 6 show sequential views of the terminated electrical cable being assembled with a positioning tool to fit a gland onto the cable;

FIG. 5b shows a close up view of the pins in FIG. 5a;

FIGS. 7 and 8 show the cable fitted with the gland being made up into the FIG. 1 connector portion;

FIGS. 9 and 10 show side and section views through the terminated cable similar to FIGS. 5 and 6; and

FIG. 11 shows an end view on the assembly of FIG. 9.

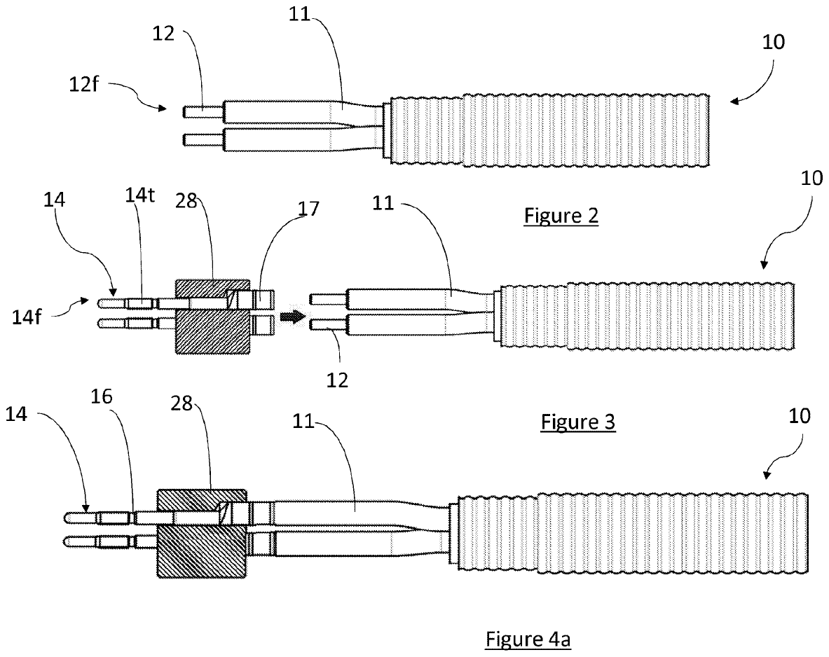

Referring now to the drawings, a three phase electrical cable 10 comprises three electrical conductors 11 in the form of cores 12 typically comprising copper wire (not all three conductors 11 are shown in each of the figures for clarity). The cable 10 typically has an armour layer and optionally an electrical insulator surrounding the cores 12. Each core 12 typically has an insulating sheath as is known in the art, and surrounding the conductors 11, the cable 10 has additional layers of insulation and armour. The conductors 11 and cores 12 are cut to length, ensuring that free ends 12f of the cores 12 extending from the cable 10 have the same axial length (in other words, they all terminate at a common axial position as shown in FIG. 2) and are stripped of insulation, ready for termination, before being made up into a first connector portion 1.

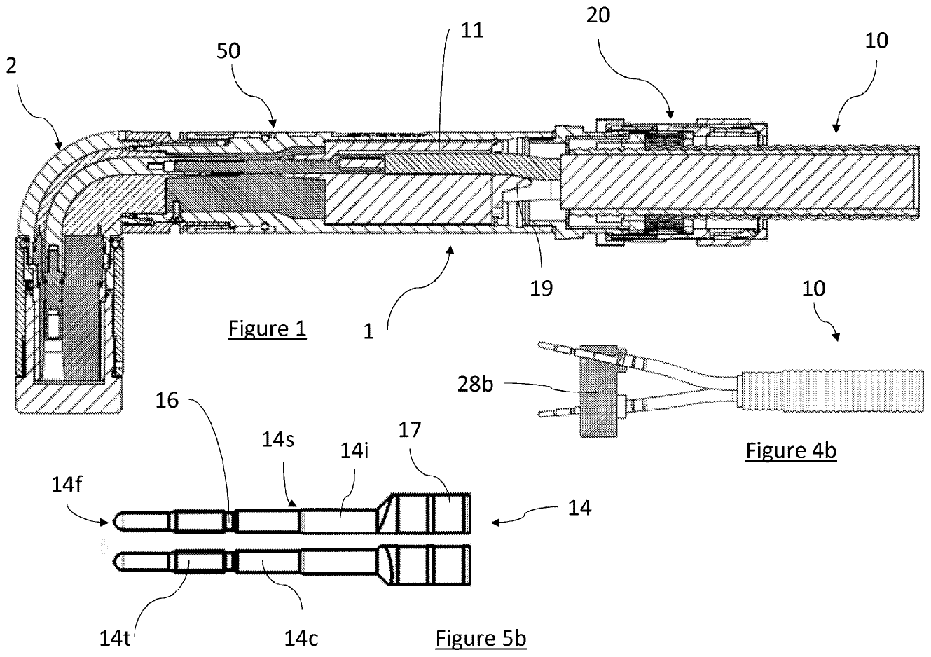

The first connector portion 1 (see FIG. 1) houses the cable 10 in a housing 51 of a first connector portion 1, for connection to a second connector portion 2, which in this example is an elbow connector portion of a wellhead penetrator on a surface wellhead. The housing 51 of the first connector portion 1 has a bore (see FIG. 8) which is counterbored with a narrow portion at an outer end containing a tapered pin housing 55 formed of e.g. PEEK, and a larger diameter portion at the opposite inner end containing an electrical insulation boot 53. The axial movement of the pin housing 55 is restricted with respect to the housing 51 by a combination of the decreasing taper on the bore of the narrow portion of the housing 51 and an array of three screws 51t (one shown in FIG. 8, with a 120° circumferential spacing between each of the screws 51t) passing radially through the housing 51 and into the pin housing 55. This optionally fixes the pin housing 55 within the housing 51, conveniently resisting movement from the inner end to the outer end beyond the point shown in FIG. 8, and likewise the axial movement of the insulation boot 53 into the larger diameter portion of the bore is arrested by a shoulder 51s, facing the inner end of the housing 51, and by the reception of tapered cones 53t on the insulation boot 53 into tapered bores of the pin housing. The pin housing 55 and insulation boot 53 are offered in sequence to the bore of the housing 51, through the inner end, until the axial movement of the pin housing 55 is arrested (e.g. by the tapered narrow portion of the bore and the axial movement of the insulation boot 53 is arrested by the shoulder 51s), at which point, the pin housing 53 is fixed in position by the screw 51t, and the insulation boot 53 is compressed against the pin housing 55. At the inner end of the housing 51, the opening of the bore is internally threaded at threaded socket 51t.

The insulating boot 53 and the pin housing 55 each have coaxial bores for receiving the conductors 11. A respective tapered cone 53t is provided on the insulation boot for each conductor 11, each of which stabs into a respective tapered socket at an inner end of the bore 55b of the pin housing 55, which narrows and is coaxial with a central straight section of the bore 55b. The bore 55b on the opposite (outer) end of the pin housing 55 is also coaxial with the central straight section, but flares radially outward at its opening onto the outer face of the pin housing 55, creating an outward facing shoulder in the bore. Optionally the insulating boot 53 and pin housing 55 are kept in place in the bore of the housing 51 by a circlip 51c engaged in a groove near the inner end of the housing 51 and axially spaced from the threaded socket 51t. In this example, the insulating boot 53 and pin housing 55 are held in axial compression within the bore of the housing 51 by the circlip 51c. The axial compression also radially compresses the cone 53t within the pin housing 55.

The free end 12f of each core 12 is fitted with a pin 14, which receives a stripped end of the core 12 within a recess in a bucket 17 formed at an inner end of the pin 14. The axis of the bucket 17 is typically offset from the axis of the pin 14, so that the outer (free) ends 14f of the pins 14 at the opposite end of the pin 14 to the bucket 17 can be arranged closer together in the first connector portion 1. In this example, the free ends 14f of the pins 14 opposite to the buckets 17 need to stab into sockets on the mating second connector portion 2 which have a fixed radial position with respect to each other; for example, the socket centres all lie on a circle with a relatively narrow diameter, so the axes of the free ends 14f of the pins 14 generally need to be closer together than the axes of the buckets 17, which need to accommodate the relatively large-diameter cores 12. Because the cores 12 are also relatively stiff and resistant to twisting and bending, the rotational position of the pins 14 relative to the cores 12 is usefully determined before the pins 14 are fixed to the cores 12, because relative rotation of the pins 14 after this is often difficult. The relative rotational positions of the pins 14 is determined in this example with a rotational positioning tool 28, as shown in FIGS. 3 and 4, which has a bore for each pin, with a narrow diameter to accept the free end 14f of the pin and a relatively larger diameter to accept the bucket 17 in its desired rotational position such that the free ends 14f of the three pins 14 are in the correct relative radial positions with respect to each other to stab accurately into the second connector portion 2 having the corresponding sockets. In the example shown in FIGS. 3 and 4, bores in the rotational positioning tool are parallel, but since the only function of the rotational positioning tool is simply to set the correct relative rotational position of the pins with respect to each other, these axes could be non-parallel, for example they could deviate, which can allow for better access for crimping tools often used to crimp the ends of the pins 14 onto the conductor cores 12. One such example with deviated bores is shown in FIG. 4b, which shows an alternative rotational positioning tool 28b, with non-parallel axes, which also determine the same rotational alignment of the buckets relative to one another, but which permit more space between larger cores 12, which is useful for crimping the pins 14 onto the cores 12 if desired.

Each pin 14 has a stepped outer diameter. The large diameter bucket 17 at the inner end of each pin steps radially down to an inner section 14i, the axis of which is offset from the axis of the bucket 17, as mentioned above. The outer diameter of the pin 14 steps down again from the inner section 14i to a central section 14c, creating a radially extending shoulder 14s which faces the free end 14f. Between the free end 14f of the pin 14 and the central section 14c, the pin has an annular groove 16, and a threaded section 14t, which has a nominal outer diameter that is the same as or at least no greater than that of the central section 14c. Each threaded section 14t is spaced a short distance from the free end 14f.

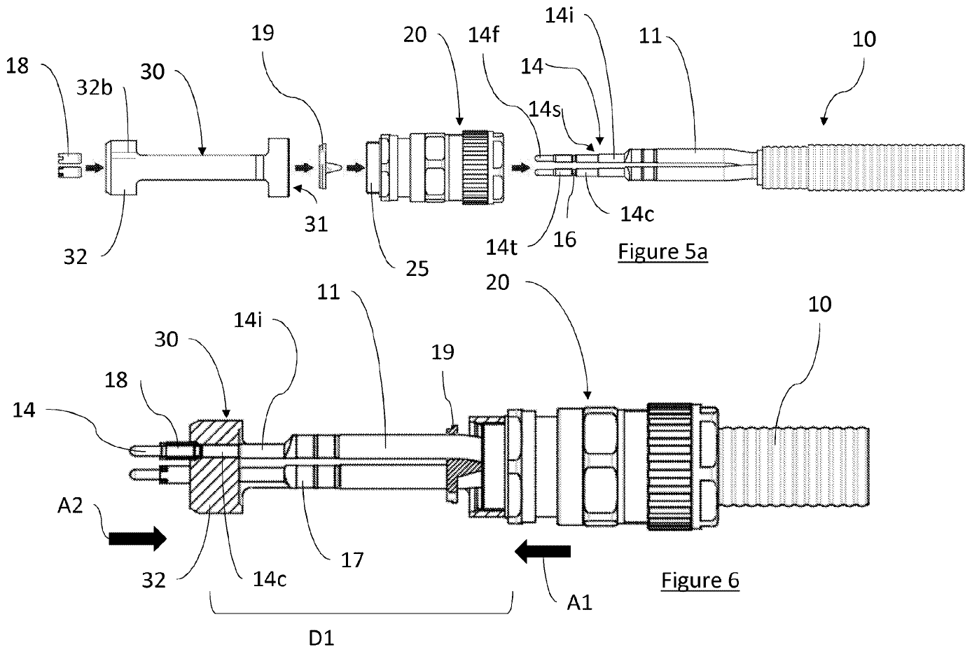

Once the pins 14 are connected to the cores 12, as shown in FIG. 5a, the pins 14 can be removed from the rotational alignment tool 28. The free ends 14f of the pins 14 are then offered to the bore of a gland 20, passing first through a first end of the gland; the gland 20 is then slid along the cable 10. The gland 20 has a body 21 through which the bore passes between the first end and a second end, and a seal 22, typically at the first end of the gland 20 through which the pins 14 pass first. The seal 22 is typically a resilient seal, for example, such as a rubber boot, which is adapted to be radially compressed between the inner surface of the body 21 and the outer surface of the armour of the cable 10, thereby preventing or restricting fluid flow past the seal when the seal 22 is in compression. The gland 20 also typically has an earth clamp 23, optionally with e.g. a metal cage that can be mechanically actuated (e.g. deformed) after being placed in the correct axial position on the cable 10, to extend radially inwards to engage the outer surface of the cable 10, thereby maintaining an earth electrical terminal in contact between the body 21 and the outer layer of the cable 10, which may also serve as a mechanical cable clamp to secure the gland 20 in a fixed axial position with respect to the cable 10. Optionally a mechanical cable clamp can be provided in the gland 20 separately from the earth clamp.

The gland 20 in this example also has a spin collar 24 at the second (outer) end; the spin collar 24 can spin freely relative to the body 21, and in this example, the spin collar 24 comprises a cylindrical boss 25 extending parallel to the axial bore, and having an external screw thread (see FIG. 5a).

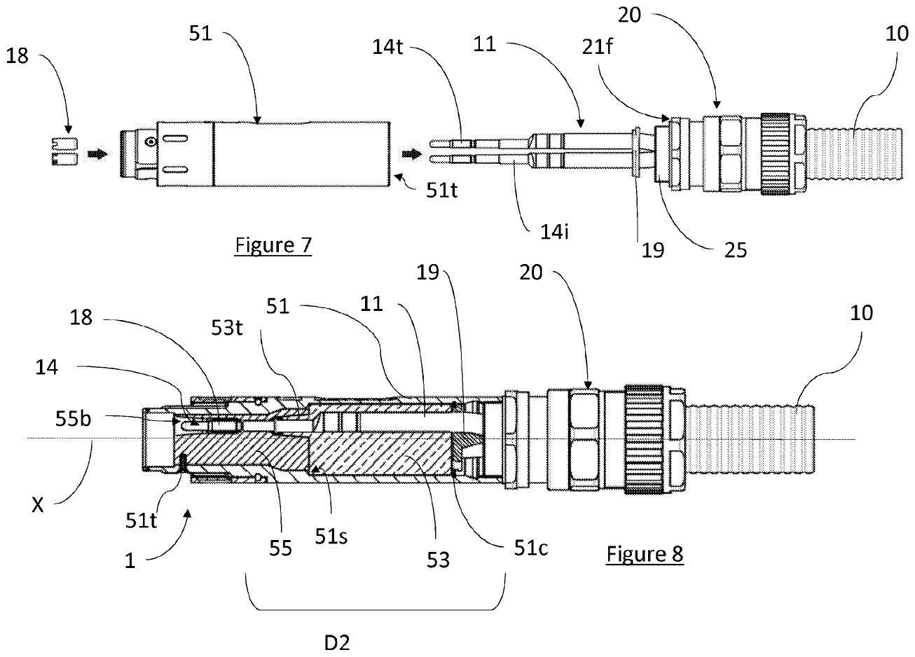

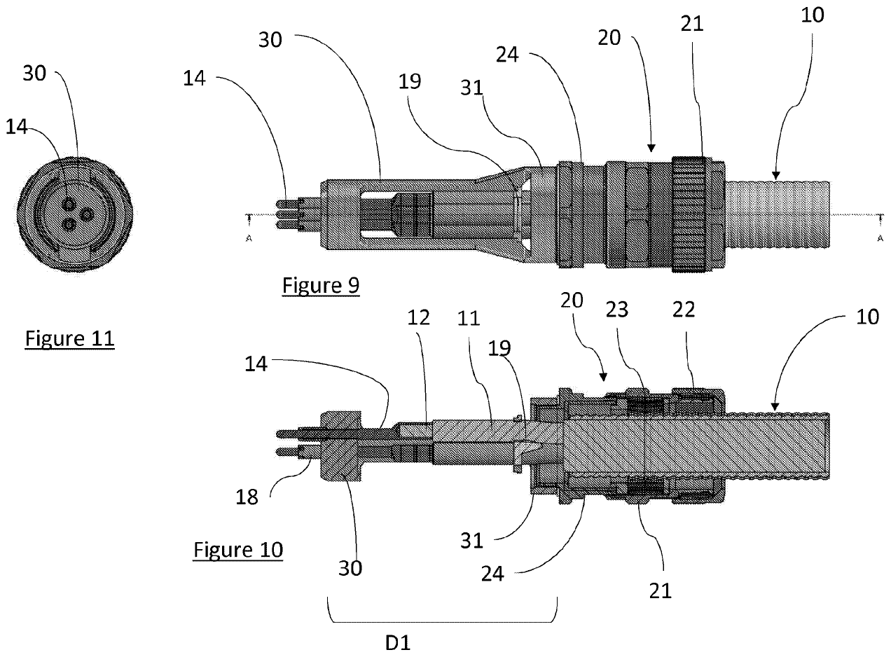

Initially the resting axial position of the gland 20 on the cable 10 is not particularly important. It is sufficient that the gland 20 slides axially over the cable 10 until the pins 14 extend through the second end of the gland 20, as shown in FIG. 7. The gland 20 has not yet been fixed to the cable 10 at this stage, and can slide freely in both axial directions along the cable 10.

After the gland 20 slides over the free ends 14f of the pins 14 and the body 21 of the gland is positioned over the armour of the cable 10 as show in the cross-section view in FIG. 10, a cable guide 19 is then inserted between the conductors 11. The cable guide has a conical nose portion facing away from the free ends 14f of the pins 14, and a flange with a cutaway for each of the conductors 11, so that the conductors lie along the cone and emerge from the cutaways at a common radial distance from an axis X which passes through the centre of the cable 10, the body 21, and the cable guide 19, and with a regular circumferential spacing between the conductors as they emerge from the cutaways. The cutaways thereby guide the radial and circumferential position of the conductors 11, which makes it easier for the conductors 11 to line up with bores through the internal structure of the conductor portion 1 as will be described below.

As shown in FIGS. 5 and 6, after the cable guide 19 has been inserted between the conductors 11, the free ends 14f of the pins 14 are inserted into a positioning tool 30, e.g. inserted into an axial bore of the positioning tool 30. The bore of the positioning tool 30 is coaxial with the axis X. The positioning tool 30 has a first (inner) end with a recessed annular socket 31 with an internal thread, through which the free ends 14f of the pins are initially passed, and a second end with a head 32 having an end plate with parallel inner and outer faces perpendicular to the axis X. The end plate on the head 32 has a bore 32b (see FIG. 11; one bore 32b is also shown in FIG. 5a) for each pin 14, each bore 32b terminating in a recessed socket on the outer surface of the end plate. Each bore 32b has an internal diameter sufficient to allow passage of the central section 14c and threaded section 14t of the free end 14f of the pin through the bore 32b, but the diameter of the bore 32b is in each case narrower than the inner section 14i of each pin 14, so the shoulder 14s cannot pass into the bore 32b and shoulders out on the inner surface of the end plate of the head 32 when the free ends 14f of the pins 14 pass a sufficient distance through the head 32, as shown in FIG. 6. Each recessed socket has an outer end opening onto the outer face of the end plate, and an inner end, with a radial inward step in diameter as the recessed socket narrows into the bore 32b. The free ends 14f of the pins 14 pass through the bores as best shown in FIG. 6, and extend a short distance from the recessed sockets on the outer face of the end plate.

At this stage, the threads in the recessed socket 31 on the first end of the positioning tool 30 and the threaded boss 25 on the second end of the gland 20 are made up, by rotating the spin collar 24 relative to the body of the gland 20 and the positioning tool 30, both of which remain rotationally static relative to the cable 10 during the connection of the positioning tool 30 and the gland 20. The threaded boss 25 screws into the socket 31 until a flange 21f on the gland body 21 is butted against a first abutment formed in this case by the end of the threaded socket 31 on the positioning tool. This limits (e.g. prevents) movement of the gland 20 relative to the positioning tool 30 in a first direction shown by arrow A1 in FIG. 6, although the gland 20 has not yet been fixed to the cable 10.

The external threads on the threaded sections 14t then engage with the internal thread on the bores of respective locknuts 18, which can move axially along the threads to a common axial location, until the locknuts 18 move into the recesses and pull the shoulders 14s on the pins 14 into abutment with the inner surface of the end plate of the head 32. The locknuts 18 limit movement of the pins 14 relative to the positioning tool 30 in the second direction A2 as shown in FIG. 6 (opposite to the first direction A1), and the shoulders 14s limit movement of the pins 14 relative to the positioning tool 30 in the opposite direction A1. Tightening the locknuts 18 on the threaded sections 14t thus compresses the head between the locknuts 18 and the shoulders 14s, preventing movement of the pins 14 (and thus the conductors 11) relative to the positioning tool 30 in both axial directions. Note that the locknuts 18 can optionally be tightened onto the head 32 of the positioning tool before the threaded boss 25 of the gland 21 is made up with the threaded socket 31 on the positioning tool 30.

With the flange 20f forced against the first abutment on the end of the threaded socket 31 on the first end of the positioning tool 30 and the locknuts 18 fixed onto the pins 14 forced against the second abutment formed by the recessed sockets on the head 32 of the positioning tool 30, the axial position of the gland 20 relative to the cable 10 is then determined by the distance between the first and second abutments and the axial position of the locknuts on the threads of the pins 14. The assembly is now in the position shown in FIG. 6, permitting the gland 20 to be fixed in position on the cable, either using a mechanical cable clamp, or by injecting a settable material such as epoxy into the body 21 of the gland 20.

Note that before the gland 20 is attached to the cable 10, the positioning tool 30 enables a precise determination of a desired pre-attachment axial position of the gland 20 relative to the cable 10, with the free ends 14t of the pins 14 at the correct axial distance from the flange 21f on the body 21 of the gland 20 (determined by the distance of the shoulders 14s from the free ends of the pins 14f). Determining the precise required axial position of the gland 20 on the cable enables the connector body 51 to be assembled onto the gland 20 in field conditions with confidence that the conductors 11, cores 12 and pins 14 are the correct length to assemble into the made up first connector portion 1, and to reliably transmit electrical power and/or signals to the second connector portion 2 on the other side of the connection.

The axial length D1 of the positioning tool 30 between two points (e.g. between the first and second abutments at opposite ends of the positioning tool 30) is precisely determined, e.g. in a factory with close tolerances. In this example, at least one first abutment is formed on the positioning tool 30 by the end face of the threaded recess 31, which receives the threaded boss 25, and which is butted against the flange 21f on the body 21 of the gland 20 in FIG. 6 when the screw threads are made up. At least one second abutment is formed at the other end of the positioning tool 30 by the inner end of the recessed socket on the head 32, which is butted against the inner ends of the locknuts 18 in the FIG. 6 position. Note that the screw threads between the threaded boss 25 and the recess 31 at one end of the positioning tool 30 act in the opposite direction to the threads between the locking nuts 18 and the threaded section 14t on the opposite end of the positioning tool 30, and as the threads between the threaded boss 25 and the recess 31 are tightened the positioning tool 30 is compressed against the locknuts 18 at the opposite end of the positioning tool 30, reducing the risk of loose connections between the components which could affect the eventual position of the gland 20 before fixing the gland 20 to the cable 10.

After making up the threads at the first and second abutments, and optionally placing the positioning tool 30 in compression (which can optionally be measured), the gland 20 is fixed to the cable 10, optionally by a mechanical clamp, and/or optionally using a settable material such as an adhesive, which is injected into the annulus between the cable 10 and the body 21. It is sufficient for the settable material to be injected only into the body 21 of the gland 20, and in this example it is confined to the body 21 and does not flow out of the body 21 into the spin collar 24 or positioning tool 30. At this stage, the gland 20 is fixed to the cable 10 in a position defined by the distance D1. After setting of the material in the body 21, the positioning tool 30 can be removed from the gland 20 and the cable 10 by unscrewing the locknuts 18 and sliding the cable 10 from the bore of the positioning tool 30, leaving the cable 10 in the configuration shown in FIG. 7, ready for assembly into the first connector portion 1. The locknuts 18 optionally have castellations on their outer end faces, best seen in FIG. 10, which can be engaged with a torque tool to make up and break up the connection between the threaded portions 14t and the locknuts 18.

The first connector portion 1 is also precisely formed with first and second abutments; the first and second abutments are typically formed in factory conditions with close tolerances, and limit the penetration of the cable 10 into the first connector portion 1 to similarly precise tolerances. In this case, a first abutment is formed on the body 51 by the end face of the threaded socket 51t, which receives the threaded boss 25 on the gland 20 in the same way as the socket 31 on the positioning tool 30. A second abutment is formed on the pin housing 55 by the radial step from the flared outer part of the bore of the pin housing 55 to the straight central section.

The axial distance D1 (see FIGS. 6 and 10) between the first and second abutments on the positioning tool 30 is the same as the axial distance D2 (FIG. 8) between the first and second abutments on the first connector portion 1.

The next step in the disclosed method is to assemble the cable 10 and gland 20 (now fixed in position on the cable 10) into the first connector portion 1. After removal of the positioning tool 30 from the end of the cable 10, the pins 14 are then offered to their respective bores extending though the insulation boot 53 and pin housing 55 of the first connector portion 1, as shown in FIG. 7, and the first connector portion 1 is then slid axially along the conductors 11 until the free ends 14f of the pins 14 emerge from the flared open ends of the bores through the pin housing 55 as shown in FIG. 8. The penetration of the pins 14 into the first connector portion 1 is limited by the radial steps in the bores of the pin housing 55, as best shown in FIG. 8.

The threaded socket 51t at the inner end of the housing 51 receives the threaded boss 25 on the outer end of the gland body 21, and the connection between the two is made up by rotating the spin collar 24 relative to the static (and fixed) body 21 of the gland 20; the first connector portion 1 also remains rotationally static relative to the gland 20 and cable 10 as the spin collar 24 rotates.

Once the end face of the threaded socket 51t is abutting firmly against the flange 21f on the body 21 of the gland 20, the locknuts 18 are then re-applied to the ends of the pins 14, and made up to the threaded portions 14t using a torque tool acting on the castellations, until the locknuts 18 have travelled along the threads on the threaded portions 14t, and have re-attained a similar axial position as in FIG. 6, and importantly, have butted against the second abutment formed on the pin housing 55 by the radial step from the flared outer part of the bore of the pin housing 55 to the straight central section. As the locknuts 18 are forced by the threads against the second abutment, this optionally also applies a small amount of tension to the conductors 11, generally sufficient to resist radial movement of the conductors 11 within the first connector portion 1 after assembly, but typically not sufficient to pull the conductors axially out of the cable 10.

The first connector portion 1 is then in the configuration shown in FIGS. 1 & 8, and is ready to plug into the second connector portion 2.

The method as herein disclosed permits the reliable termination of the cable 10 into the first connector portion 1 in field conditions with confidence that the conductors 11 will reliably communicate across the connection. The method also permits the re-use of existing cables 10 at the well site, permitting reductions in waste of existing materials, and reductions in transportation costs for new cables. Also, the method permits the field assembly of cable terminations which utilise e.g. gland and connector portion components that are ATEX compliant and suitable for use in hazardous atmospheres, without reliance on factory facilities to perform the termination of the cable.

1. A method of terminating an electrical conductor for connection to a wellhead of an oil or gas well, the method comprising:
passing the electrical conductor through a bore of a gland;
engaging the electrical conductor with a positioning tool;
engaging the gland with the positioning tool;
limiting movement of the gland relative to the positioning tool in a first direction;
limiting movement of the electrical conductor relative to the positioning tool in a second direction, wherein the second direction is opposite to the first direction;
fixing the gland to the electrical conductor;
disengaging the positioning tool from the gland and the electrical conductor;
passing the electrical conductor through the body of a connector portion;
engaging the gland with the connector portion;
limiting movement of the gland relative to the connector portion in the first direction; and
limiting movement of the electrical conductor relative to the connector portion in the second direction.

2. A method as claimed in claim 1, wherein the positioning tool has a first abutment which engages the gland to limit the movement of the gland relative to the positioning tool, and a second abutment which engages a locking device to limit the movement of the electrical conductor relative to the positioning tool.

3. A method as claimed in claim 2, wherein the connector portion has a first abutment which engages the gland to limit the movement of the gland relative to the connector portion, and a second abutment which engages the locking device to limit the movement of the electrical conductor relative to the connector portion.

4. A method as claimed in claim 3, wherein the axial distance between the first and second abutments on the positioning tool is equal to the axial distance between the first and second abutments on the connector portion.

5. A method as claimed in claim 3, including fixing the gland at an axial position relative to the free end of the electrical conductor which is determined by the axial distance between the first and second abutments on the positioning tool.

6. A method as claimed in claim 1, including locking the electrical conductor against movement in the second direction with a locking device.

7. A method as claimed in claim 6, including locking the position of the locking device relative to the electrical conductor.

8. A method as claimed in claim 6, including locking the locking device at a fixed distance from a free end of the conductor.

9. A method as claimed in claim 6, including making up mating screw threads between at least one of the positioning tool and the gland, the positioning tool and the locking device, the connector portion and the gland, and the connector portion and the locking device.

10. A method as claimed in claim 6, including locking the positioning tool against movement relative to the electrical conductor in both first and second axial directions.

11. A method as claimed in claim 1, wherein the gland and positioning tool are connected by screw thread connection, and wherein the screw thread connection includes a spin collar adapted to rotate relative to a body of the gland and the positioning tool, permitting the screw thread connection to be made up without rotation of the body of the gland and the positioning tool.

12. A method of terminating an electrical conductor for connection to a wellhead of an oil or gas well, the method comprising:
passing the electrical conductor through a bore of a gland;
engaging the electrical conductor with a positioning tool;
engaging the gland with the positioning tool;
limiting movement of the gland relative to the positioning tool in a first direction with a first abutment on the positioning tool;
limiting movement of the electrical conductor relative to the positioning tool in a second direction with a second abutment on the positioning tool, wherein the second direction is opposite to the first direction;
fixing the gland to the electrical conductor;
disengaging the positioning tool from the gland and the electrical conductor;
passing the electrical conductor through the body of a connector portion;
engaging the gland with the connector portion;
limiting movement of the gland relative to the connector portion in the first direction with a first abutment on the connector portion; and limiting movement of the electrical conductor relative to the connector portion in the second direction with a second abutment on the connector portion, and wherein:
the axial distance between the first and second abutments on the positioning tool is equal to the axial distance between the first and second abutments on the connector portion.

13. A method as claimed in claim 12, including fixing the gland at an axial position relative to the free end of the electrical conductor which is determined by the axial distance between the first and second abutments on the positioning tool.

14. A kit of parts for an electrical conductor for connection to a wellhead of an oil or gas well, the kit comprising:
a gland having a bore to receive the electrical conductor;
a positioning tool;
the gland and the positioning tool having formations adapted to connect the gland to the positioning tool;
a connector portion comprising a bore adapted to receive the electrical conductor;
the connector portion being adapted to connect to the formation on the gland; wherein:
the positioning tool has a first abutment adapted to limit movement of the gland relative to the positioning tool in a first direction and a second abutment adapted to limit movement of the electrical conductor relative to the positioning tool in a second direction;
the gland is adapted to be fixed to the electrical conductor;
wherein the positioning tool can be disengaged from the gland and the electrical conductor after the gland is fixed to the electrical conductor, and wherein the connector portion is adapted to receive the electrical conductor after the positioning tool has been disengaged from the gland such that the connector portion engages the formation on the gland; and wherein:
the connector portion has a first abutment adapted to limit movement of the gland relative to the connector portion in the first direction and a second abutment adapted to limit movement of the electrical conductor relative to the connector portion in the second direction.

15. A kit of parts as claimed in claim 14, wherein the axial distance between the first and second abutments on the positioning tool is equal to as the axial distance between the first and second abutments on the connector portion.

16. A kit of parts as claimed in claim 14, including a locking device adapted to lock the electrical conductor against movement in the second direction.

17. A kit of parts as claimed in claim 16, wherein the locking device is adapted to engage the electrical conductor and adapted to engage the second abutment on the connector portion and the second abutment on the positioning tool.

18. A kit of parts as claimed in claim 14, wherein the positioning tool is adapted to be locked against movement relative to the electrical conductor in both first and second axial directions.

19. A kit of parts as claimed in claim 14, including mating screw threads between at least one of the positioning tool and the gland, the positioning tool and the locking device, the connector portion and the gland, and the connector portion and the locking device.
